(19) United States
(12) Patent Application Publication
(10) Pub. No.: US 2024/0396208 A1
(43) Pub. Date: Nov. 28, 2024

(54) Aperiodic Monotile Phased Array Antenna and System with No Grating Lobes

(71) Applicant: Orbit Communication Systems Ltd., Netanya (IL)

(72) Inventors: Hanan KEREN, Kfar Sava (IL); Shlomi LEVI, Kibbutz Sde Boker (IL); Alon LEIB, Or Yehuda (IL)

(21) Appl. No.: 18/672,177

(22) Filed: May 23, 2024

Related U.S. Application Data
(60) Provisional application No. 63/468,559, filed on May 24, 2023.

(51) Int. Cl. H01Q 3/26

(52) U.S. Cl. CPC H01Q 3/26

(57) ABSTRACT

Phased array antennas and systems having no grating lobes include an aperiodic monotile phased array (AMPA) consisting of a multiplicity of monotile antenna elements. The monotile antenna elements may have the shape of polykite hats. Various embodiments of the monotile antenna elements, including details of their geometry, material composition and excitation, are provided.

### CROSS-REFERENCE TO RELATED APPLICATIONS

This application is related to and claims priority from commonly owned U.S. Provisional Patent Application No. 63/468,559 entitled “Phased Array SATCOM Antenna with No Grating Lobes Based on an Aperiodic Monotile Arrangement”, filed on 24 May 2023, the disclosure of which is incorporated by reference in its entirety herein.

### TECHNICAL FIELD

The present invention relates to phased array antennas and systems, and specifically to an Aperiodic Monotile Phase Array (AMPA) antenna and system having no grating lobes.

### BACKGROUND OF THE INVENTION

In phased array antennas, such as those used in satellite communication (SATCOM) systems, the cost of phase shifters and transmit/receive components increases with the number of array elements. Large-spacing periodic arrays may be used to reduce the number of elements, however, they suffer from grating lobes when the element spacing in the array is larger than a half-wavelength.

For example, international publication number WO 2021/198990 A1, to J. P. Turpin et al., dated Oct. 7, 2021, and entitled Field-assembled Modular Phased Array Satcom Terminal teaches a field-assembled satellite communication terminal having a plurality of discrete, modular aperture blocks. Each aperture block contains an electrically steered antenna aperture, and a plurality of interconnection ports for power and data communications between the plurality of aperture blocks. Various tilings or tessellations of a plane may be used to form planar phased array antennas consisting of a large number of aperture blocks. Among the possibilities are periodic tilings of the plane, such as tiling with regular hexagons, and aperiodic tilings of the plane using, for example, irregular convex pentagons.

In order to reduce the amplitude of grating lobes, while retaining a large element spacing, various other types of aperiodic arrays have been investigated.

Chinese patent publication number CN111985145A, to G. Winjeng et al., dated Nov. 24, 2020, and entitled “Large-spacing phased array antenna grating lobe suppression method and suppression system” discloses the use of a genetic algorithm to suppress grating lobes in a large-spacing phased array antenna in order to suppress grating lobes.

A technical paper by J. Diao et al., entitled “Sidelobe Level and Aperture Efficiency Optimization for Tiled Aperiodic Array Antennas, appearing in IEEE Transactions on Antennas and Propagation, vol. 65, no. 12, December 2017, teaches the use of discrete rotated tiles with element positions and tile orientations optimized to minimize peak sidelobe level.

A technical paper by Y. Wang et al., entitled “A Low-Cost Wideband Dual Circularly Polarized Aperiodic 2-D Phased Array”, appearing in IEEE Transactions on Antennas and Propagation, vol. 71, no. 4, April 2023, hereinafter referred to as “YW2023”, presents an aperiodic array optimization method based upon a perturbation principle, to solve for the non-zero grating lobes of a large spacing scanning array and thinning the number of array elements.

Finally, in the field of pure mathematics, a pre-print by David Smith et al., entitled “An Aperiodic Monotile”, appearing in arXiv:2303.10798v1 [math.CO] and dated Mar. 20, 2023, hereinafter referred to as “DS2023”, presents a solution to a long-standing problem involving a single shape known as an aperiodic monotile, or “einstein” (literally “one stone”), that admits never-repeating tiling patterns over an infinite plane.

### SUMMARY OF THE INVENTION

The invention provides embodiments of a phased array antenna and system having an aperiodic monotile phased array (hereinafter “AMPA”) and no grating lobes.

According to one aspect of the presently disclosed subject matter, there is provide a phased array antenna for receiving and/or transmitting electromagnetic radiation. The antenna includes a multiplicity of monotile antenna elements. Each monotile antenna element includes an antenna feed whose position is within an area of the monotile antenna element, and the multiplicity of monotile antenna elements is configured in an aperiodic monotile phased array (AMPA) such that the antenna has no grating lobes.

According to some aspects, the area of the monotile antenna element is bounded by a monotile fence.

According to some aspects, the position of the antenna feed is determined by vertices of the monotile fence.

According to some aspects, the monotile antenna element has the shape of a polykite hat.

According to some aspects, the monotile antenna element comprises a patch antenna, a crossed-dipole antenna, or a horn antenna.

According to some aspects, the antenna feed comprises a material containing Copper, Aluminum, or an alloy containing Copper or Aluminum.

According to some aspects, the multiplicity of monotile antenna elements is fed by time-varying excitations which are mutually orthogonal in space and time.

According to some aspects, the antenna operates in at least one electromagnetic radiation band belonging to a group consisting of X, Ku, and/or Ka electromagnetic bands.

According to some aspects, the antenna transmits and/or receives electromagnetic signals in a Satellite Communication (SATCOM) system.

According to some aspects, a directivity of the antenna decreases with an increase in a scan angle according to a cosine of the scan angle.

According to another aspect of the presently disclosed subject matter, there is provided a phased array system for receiving and/or transmitting electromagnetic radiation. The system includes a phased array antenna, the antenna further including a multiplicity of monotile antenna elements. Each monotile antenna element includes an antenna feed whose position is within an area of the monotile antenna element, and the multiplicity of monotile antenna elements is configured in an aperiodic monotile phased array (AMPA) such that the antenna has no grating lobes.

According to some aspects, the phased array system further includes at least one of a group consisting of a phase-locked-loop (PLL), an encoder, a digital-to-analog converter (ADC), an analog-to-digital converter (ADC), and a transmit/receive switch.

According to some aspects, the system operates in at least one electromagnetic band belonging to a group consisting of X, Ku, and Ka electromagnetic bands.

According to some aspects, the system transmits and/or receives electromagnetic signals in a Satellite Communication (SATCOM) system.

According to some aspects, a directivity of the phased array antenna decreases with an increase in a scan angle according to a cosine of the scan angle.

### BRIEF DESCRIPTION OF THE DRAWINGS

Some embodiments of the present invention are herein described, by way of example only, with reference to the accompanying drawings. With specific reference to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

The patent or application file contains at least one drawing executed in color. Copies of this patent or patent application publication with color drawing(s) will be provided by the Office upon request and payment of the necessary fee.

FIG. 1A: A schematic drawing of an exemplary phased array antenna having an aperiodic monotile phased array (AMPA) and no grating lobes, in accordance with the invention.

FIG. 1B: A schematic drawing of the exemplary phased array antenna of FIG. 1A, in which the monotile fences have been removed.

FIG. 2A: A detailed drawing of the dimensions of an exemplary single monotile antenna element.

FIG. 2B: A detailed drawing of the positions of the central feed and of the monotile fence vertices of the single monotile antenna element of FIG. 2A.

FIG. 3A: A three-dimensional radiation pattern of the exemplary phased array antenna of FIG. 1A, having no grating lobes, in accordance with the invention.

FIG. 3B: A two-dimensional cross-section of the three-dimensional radiation pattern of FIG. 3A, having no grating lobes, in accordance with the invention.

FIG. 4: A graph of the directivity of the exemplary phased array antenna of FIG. 1A, for different antenna scan angles.

FIG. 5: A block diagram of an exemplary phased array system having an AMPA and no grating lobes, in accordance with the invention.

### DETAILED DESCRIPTION OF THE INVENTION

### Grating Lobes

The far-field pattern of a planar phased array antenna, consisting of M elements is characterized by the expressions,

$$\\ \begin{matrix}f ( θ , φ ) = g ( θ , φ ) S ( θ , φ ) & ( equation 1 )\end{matrix}$$

$$\\ \begin{matrix}S ( θ , φ ) = {\sum }_{m = 1}^{M} {a}_{m} {e}^{{}_{} jk [ {x}_{m} sin ( θ ) cos ( φ ) + {y}_{m} sin ( θ ) sin ( φ ) ]} & ( equation 2 )\end{matrix}$$

where angles (θ,φ) denote off-boresight angles, λ is the wavelength,

$$\\ k = \frac{2 π}{λ} ,$$

aₘ is the (current) amplitude, (xₘ,yₘ) are the positions of the m-th element, g(θ,φ) is the single element pattern, and S(θ,φ) is the (complex) array factor. If the spacing between the elements of the phased array is larger than or equal to half a wavelength, the magnitude of the array factor typically has multiple maxima, or “grating lobes”, corresponding to half-integer values of the term in braces in equation 2. A variety of simulation software packages, such as CST Microwave Studio®, are available to evaluate the terms in equations 1 and 2.

The emergence of grating lobes in the array factor, S(θ,φ), is usually undesired. Grating lobes can interfere with neighbouring satellites, resulting in a need to decrease the total output power of the radiofrequency (RF) system in order to meet SATCOM regulation standards, such those of the US Federal Communications Commission (FCC) and the European Telecommunications Standards Institute (ETSI).

Phased Array Antenna with No Grating Lobes

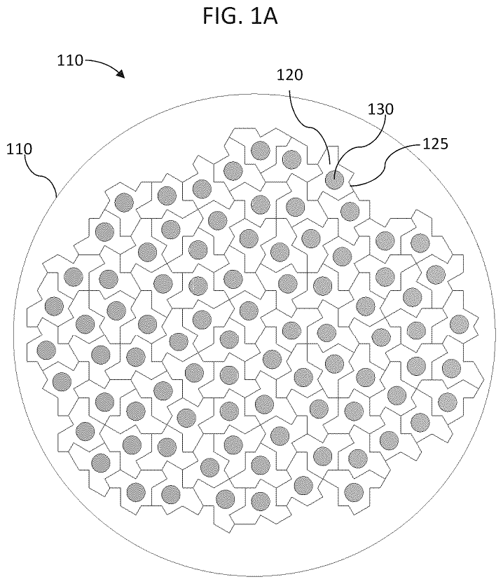

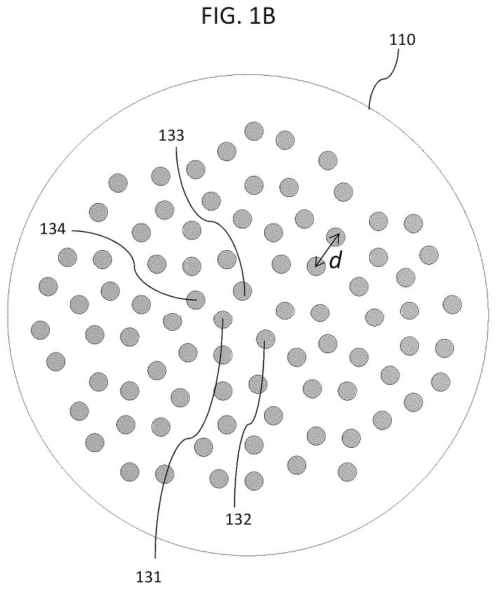

FIG. 1A shows a schematic drawing of an exemplary phased array antenna 100 having an aperiodic monotile phased array (AMPA) and no grating lobes, in accordance with the invention. The AMPA in this example consists of a multiplicity of M=85 adjacent monotile antenna elements, surrounded by an exemplary circular aperture 110. The effective area of aperture 110 and the number of monotile antenna elements, M, are generally determined by system constraints, such as the antenna gain and the antenna beamwidth in azimuth and elevation, at different scanning angles.

A single monotile antenna element 120 in FIG. 1A is surrounded by a boundary, or “monotile fence”, 125 whose shape is that of an irregular polygon, inside of which is an antenna feed 130. The other (M−1) elements of the AMPA are shifted in the X-Y plane and are rotated with respect to element 120 by a rotation angle, α. In the AMPA of exemplary antenna 100, the rotation angles are selected from the set α={αᵢ, i=0, 1, 2, . . . 6}={−90°,−30°, 30°, 90°, 150°, 210°, 270°}.

The geometric shape of the monotile fence 125 is known as a “hat polykite” or “polykite hat”, and is described in detail in reference DS2023, which is familiar to those skilled in the mathematical discipline of aperiodic tilings. This specific shape has been proven mathematically to enable an aperiodic tiling over a plane of infinite extent.

The antenna feed 130 inside the monotile fence 125 may be a circle, a square or any other conducting shape, and its current excitation may have linear, circular, or elliptical polarization. Furthermore, the antenna feed 130 may be implemented, for example, as a conducting patch antenna feed, a non-planar crossed-dipole antenna, or a horn antenna. The material composition of the antenna feed may include elemental Copper or Aluminum, or an alloy containing these elements.

FIG. 1B is a schematic drawing of the exemplary phased array antenna of FIG. 1A, in which the defining monotile fences 125 have been removed. The white gaps between the antenna feeds 130 are either empty space or are filled with a material which may be either non-conducting or conducting. The AMPA is sparse, in the sense that (xₘ,yₘ) does not have a constant distance “d” between neighbouring feed sources, and it also may exceed a half wavelength without incurring grating lobes. The antenna feeds 131, 132, 133, and 134 are fed by current excitations which are orthogonal both in space and in time.

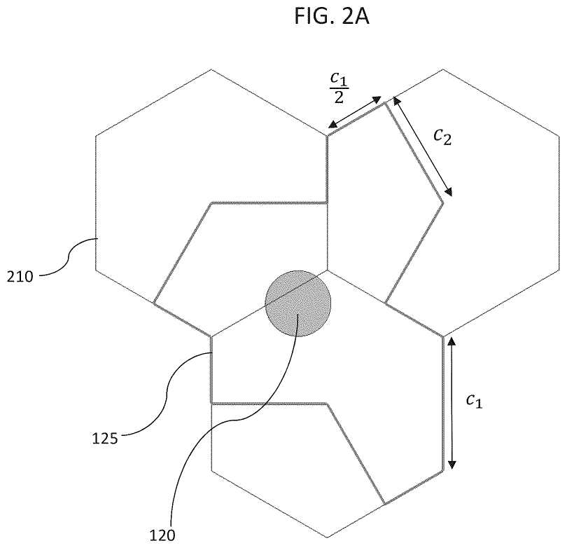

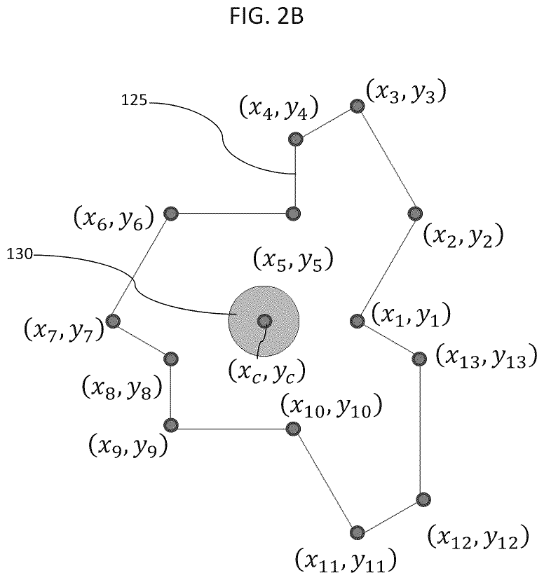

FIG. 2A shows a detailed drawing of the dimensions of an exemplary single monotile antenna element bounded by a monotile fence 125 (drawn in red) surrounding portions of three adjacent regular hexagons 210 (drawn in blue). Each hexagon has the same side length c₁. The parameter c₁ is an arbitrary scaling factor, whose value generally depends upon the frequency range over which antenna 100 is required to operate. The monotile fence 125 is made up of twelve connected line segments having lengths of c₁, c₁/2, or c₂. The latter is equal to √3/2 c₁, which is also known as the apothem of the hexagons 210.

FIG. 2B shows a detailed drawing of the positions of the antenna feed 130 and of the monotile fence vertices of the single monotile antenna element of FIG. 2A. The phase center of the antenna feed 130 is located at a position (x_{c},y_{c}), which may be anywhere within the fence 125. The antenna feed position (x_{c},y_{c}) is typically defined as an average over the coordinates of some, or all, of the vertices. In FIG. 2B, for example, x_{c}=(x₁+x₈)/2, and y_{c}=(y₅+y₁₀)/2. The same averaging is used in all of the M monotiles of the AMPA.

The twelve vertices of the monotile fence 125 are located at positions (xⱼ,yⱼ), j=1, 2, 3 . . . 12. The positions of four of these vertices are given explicitly in following table.

TABLE 1
Monotile antenna element rotation angles and vertex positions

| Feed | Rotation | Shifted | Shifted |
|---|---|---|---|
| label | angle | x-coordinate | y-coordinate |
| 131 | α₆ = 270° | x₁ = x_{c} cos(α₆) | y₁ = x_{c} sin(α₆) |
| 132 | α₄ = 150° | x₂ = 2.25C₁ + x_{c} cos(α₄) | y₂ = −1.5C₂ + x_{c} sin(α₄) |
| 133 | α₁ = −30° | x₃ = 0.75C₁ + x_{c} cos(α₁) | y₃ = 1.5C₂ + x_{c} sin(α₁) |
| 134 | α₁ = −30° | x₄ = −1.5C₁ + x_{c} cos(α₁) | y₄ = C₂ + x_{c} sin(α₁) |

Each of the antenna feeds 131, 132, 133, and 134 receives a different current excitation. The phases (ϕ) of the excitations depend upon wavelength (λ) and the “tilt” angles, or off-boresight angles, during antenna scanning, which are denoted by the off-zenith angle Theta (θ) and by the rotation angle Phi (φ). The following table shows exemplary expressions for the phases of the feed excitations.

TABLE 2
Exemplary phases (ϕ) of antenna feed excitations
Feed Rotation label angle (α) Phase (ϕ)

| | | |
|---|---|---|
| 131 | α₆ = 270° | ${ϕ}_{1} = \frac{2 π}{λ} sin ( θ ) [ {x}_{1} cos ( φ ) + {y}_{1} sin ( φ ) ] - {α}_{6}$ |
| 132 | α₄ = 150° | ${ϕ}_{2} = \frac{2 π}{λ} sin ( θ ) [ {x}_{2} cos ( φ ) + {y}_{2} sin ( φ ) ] - {α}_{4}$ |
| 133 | α₁ = −30° | ${ϕ}_{3} = \frac{2 π}{λ} sin ( θ ) [ {x}_{3} cos ( φ ) + {y}_{3} sin ( φ ) ] - {α}_{1}$ |
| 134 | α₁ = −30° | ${ϕ}_{4} = \frac{2 π}{λ} sin ( θ ) [ {x}_{4} cos ( φ ) + {y}_{4} sin ( φ ) ] - {α}_{1}$ |

In the last column of Table 2, the values of α₆, α₅ and α₂ are to be expressed in radians. Each of the monotile antenna elements may be mirrored, or “flipped, as necessary, without changing the value of the rotation angle (α) used for calculating the phase of its feed excitation. The excitations in Table 2 are mutually orthogonal in space and time.

The amplitudes of the antenna feed excitations may be uniform, or they may be adjusted for sidelobe “tapering”, i.e. the mitigation of sidelobe intensities. The latter may be needed to comply with antenna system requirements.

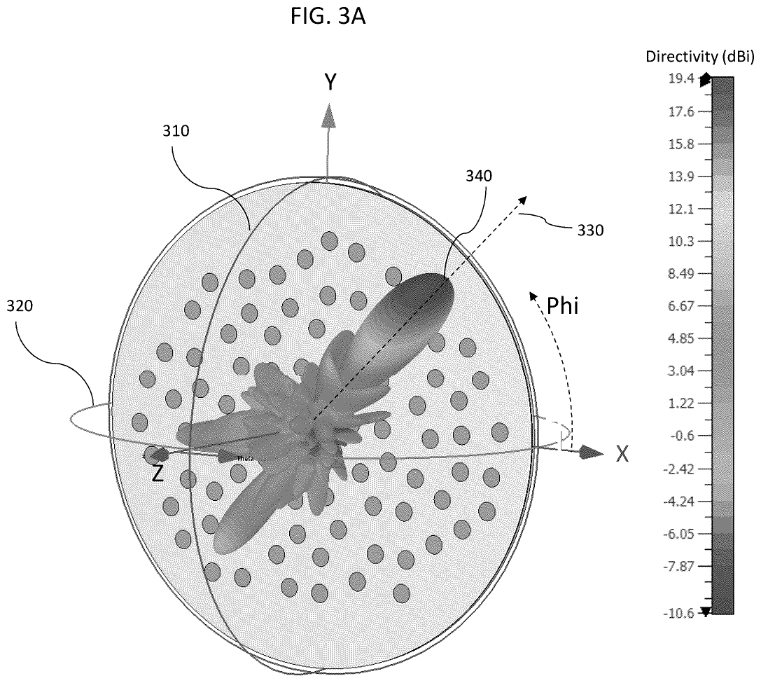

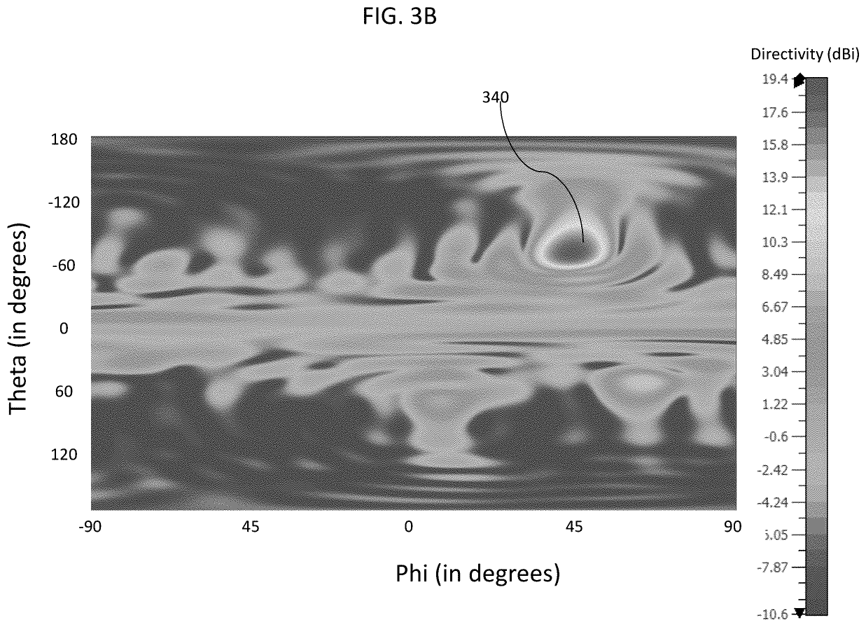

FIG. 3A shows a three-dimensional (3D) radiation pattern of the exemplary phased array antenna of FIG. 1A, having no grating lobes, in accordance with the invention. Lines 310 and 320 denote a meridional and an equatorial circle, respectively. The (3D) pattern in FIG. 3A has been calculated by a standard simulation software package, for the case of the highest operating frequency used in a Ka-band SATCOM antenna, at 31 gigahertz (GHz). The directivity in units of isotropic decibels (dBi) is color-coded using the color bar on the right side of the figure. The antenna is tilted through an angle Phi=45° with respect to the azimuthal (X-Z) plane. The antenna boresight is indicated by a dashed line 330 passing through the point of maximum directivity 340.

The 3D radiation pattern in FIG. 3A shows a single main lobe, several sidelobes, and no grating lobes. This is seen even more clearly in FIG. 3B, which shows a two-dimensional cross-section of the three-dimensional radiation pattern of FIG. 3A. The color bar in FIG. 3B is the same as that of FIG. 3A. There is a single main lobe surrounding the point of maximum directivity 340, and no grating lobes, as a result of the aperiodic nature of the AMPA in phased array antenna 100.

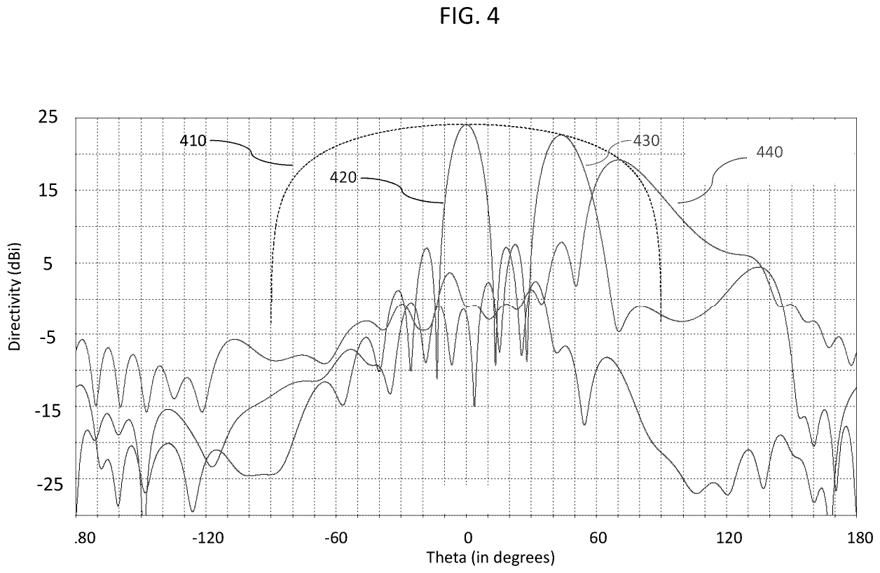

FIG. 4 shows a graph of the directivity of the exemplary phased array antenna of FIG. 1A for different antenna scan angles, with directivity in dBi plotted on the vertical axis and off-zenith angle (Theta) in degrees plotted on the horizontal axis. The plots 420, 430, and 440 correspond to an antenna tilt in Phi of 45° combined with a tilt in Theta equal to: 0° for plot 420 (in blue), 45° for plot 430 (in green), and 70° for plot 440 (in red). Each of these three plots has a single maximum in directivity, corresponding to a single main beam and no grating lobes.

The dashed plot 410 (in black) denotes the theoretical maximum directivity that can be achieved. The latter has a geometric fall-off equal to cos (Theta), for a fixed value of Phi. Note that, in each of the plots 420, 430, and 440, the point of maximum gain touches the dashed plot 410. This indicates that the fall-off in directivity with the scan off-zenith angle (Theta) of the exemplary phased array antenna 100 is in accordance with the theoretical maximum that can be achieved in the absence of grating lobes.

Phased Array System with No Grating Lobes

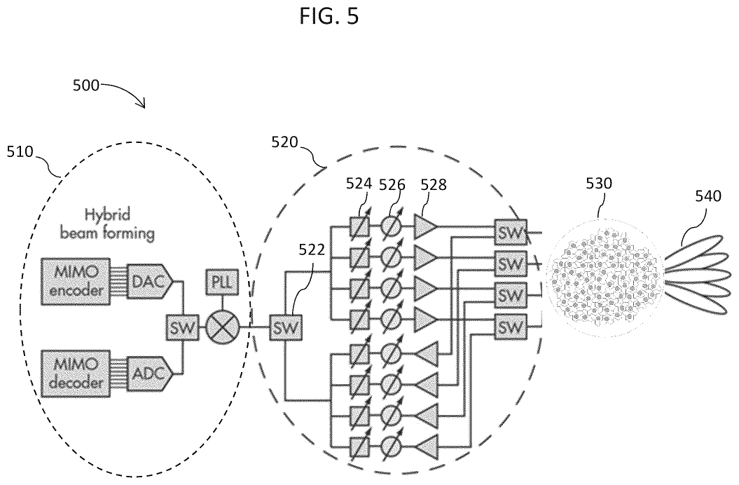

FIG. 5 shows a layout of a phased array system 500, in accordance with the invention. System 500 includes a phased array antenna 530, having an AMPA with a multiplicity of M=58 monotile antenna elements, arranged for example as in FIG. 1A. Antenna 530 forms a plurality of main beam patterns 540, each of which has no grating lobes.

In system 500, a digital control unit 510 is configured to enable hybrid beamforming and/or electronic scanning. As shown in FIG. 5, unit 510 may include, for example, two multiple-input multiple-output (MIMO) encoders, one of which provides digital signals to a digital-to-analog converter (DAC), and one of which provides analog signals to an analog-to-digital converter (ADC). A phase-locked-loop (PLL) is used to coherently combine multiple signals propagating to and from the phased array antenna 530.

A front-end current supply unit 520 provides radiofrequency (RF) current excitations to each of the N monotile antenna elements in the AMPA. The excitation amplitudes and phases are controlled by attenuators 524, phase shifters 526, and amplifiers 528. A transmit/receive switch 522 enables switching between transmission and reception.

Although the use of phased array antennas and systems with no grating lobes is especially advantageous for SATCOM systems that typically operate in X, Ku, and Ka frequency bands, the principles of the invention may be applied readily by those skilled in the art of RF antenna design to provide antennas with no grating lobes for virtually any frequency band of the electromagnetic spectrum, and for a variety of applications, such as radar and wireless communication.

In general, the descriptions of the various embodiments of the present disclosure have been presented for purposes of illustration but are not intended to be exhaustive or limited to the embodiments disclosed. Many other modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A phased array antenna for receiving and/or transmitting electromagnetic radiation, the antenna comprising a multiplicity of monotile antenna elements,
wherein each monotile antenna element comprises an antenna feed whose position is within an area of the monotile antenna element, and the multiplicity of monotile antenna elements is configured in an aperiodic monotile phased array (AMPA) such that the antenna has no grating lobes.

2. The phased array antenna of claim 1 wherein the area of the monotile antenna element is bounded by a monotile fence.

3. The phased array antenna of claim 2 wherein the position of the antenna feed is determined by vertices of the monotile fence.

4. The phased array antenna of claim 1 wherein the monotile antenna element has the shape of a polykite hat.

5. The phased array antenna of claim 1 wherein the monotile antenna element comprises a patch antenna, a crossed-dipole antenna, or a horn antenna.

6. The phased array antenna of claim 1 wherein the antenna feed comprises a material containing Copper, Aluminum, or an alloy containing Copper or Aluminum.

7. The phased array antenna of claim 1 wherein the multiplicity of monotile antenna elements is fed by time-varying excitations which are mutually orthogonal in space and time.

8. The phased array antenna of claim 1 wherein the antenna operates in at least one electromagnetic radiation band belonging to a group consisting of X, Ku, and/or Ka electromagnetic bands.

9. The phased array antenna of claim 1 wherein the antenna transmits and/or receives electromagnetic signals in a Satellite Communication (SATCOM) system.

10. The phased array antenna of claim 1 wherein a directivity of the antenna decreases with an increase in a scan angle according to a cosine of the scan angle.

11. A phased array system for receiving and/or transmitting electromagnetic radiation, the system comprising a phased array antenna, the antenna further comprising a multiplicity of monotile antenna elements,
wherein each monotile antenna element comprises an antenna feed whose position is within an area of the monotile antenna element, and the multiplicity of monotile antenna elements is configured in an aperiodic monotile phased array (AMPA) such that the antenna has no grating lobes.

12. The phased array system of claim 11 further comprising at least one of a group consisting of a phase-locked-loop (PLL), an encoder, a digital-to-analog converter (ADC), an analog-to-digital converter (ADC), and a transmit/receive switch.

13. The phased array system of claim 11 wherein the system operates in at least one electromagnetic band belonging to a group consisting of X, Ku, and Ka electromagnetic bands.

14. The phased array system of claim 11 wherein the system transmits and/or receives electromagnetic signals in a Satellite Communication (SATCOM) system.

15. The phased array antenna system of claim 11 wherein a directivity of the phased array antenna decreases with an increase in a scan angle according to a cosine of the scan angle.
